(19) United States
(12) Patent Application Publication
(10) Pub. No.: US 2025/0024519 A1
(43) Pub. Date: Jan. 16, 2025

(54) WIRELESS COMMUNICATION METHOD, WIRELESS TERMINAL AND WIRELESS NETWORK NODE THEREOF

(71) Applicant: ZTE Corporation, Shenzhen (CN)

(72) Inventors: Zhihong QIU, Shenzhen (CN); Yuan GAO, Shenzhen (CN); He HUANG, Shenzhen (CN)

(21) Appl. No.: 18/902,792

(22) Filed: Sep. 30, 2024

Related U.S. Application Data
(63) Continuation of application No. PCT/CN2022/110931, filed on Aug. 8, 2022.

(51) Int. Cl. H04W 74/0833; H04W 56/00

(52) U.S. Cl. CPC H04W 74/0833; H04W 56/001

(57) ABSTRACT

A wireless communication method for use in a wireless terminal is disclosed. The method comprises reporting, to a wireless network node, random access, RA, information of at least one RA procedure.

### CROSS-REFERENCE TO RELATED APPLICATIONS

This application is a continuation of International Patent Application No. PCT/CN2022/110931, filed on Aug. 8, 2022, the disclosure of which is incorporated herein by reference in its entirety.

### TECHNICAL FIELD

This document is directed generally to wireless communications, and in particular to reporting random access information.

### BACKGROUND

RACH (random access channel) optimization has been a part of SON (self-organizing networks) function, which serves multiple purposes, e.g., avoiding RACH resource congestion among neighbor cell/networks and helping optimization of RACH configuration to improve resource efficiency. The RACH resource configuration is enhanced to support RA (random access) partition resource, to allow RA resources to be divided to support different features for different types of UE (user equipment). However, a report from the UE may not be able to provide sufficient log specific information associated with the RA partition related RA resources. Under such a condition, an NW (network) cannot acknowledge whether and how to perform corresponding optimization on the RACH configuration. Furthermore, similar issues also exist in the RA procedure initiated for performing LBT (Listen Before Talk) recovery in unlicensed spectrum since the UE does not log RA information for RA procedure initiated in the unlicensed spectrum.

### SUMMARY

This document relates to methods, systems, and devices for reporting RA information, and in particular to methods, systems, and devices for reporting RA information associated with the RA partition related RA resources and/or the unlicensed spectrum.

The present disclosure relates to a wireless communication method for use in a wireless terminal. The method comprises reporting, to a wireless network node, random access (RA) information of at least one RA procedure.

Various embodiments may preferably implement the following features:

Preferably, the RA information comprises information associated with utilizing RA channel, RACH, resources associated with one or more features that are applicable for the RA procedure.

Preferably, the RA information of each RA procedure comprises at least one of: a feature type, indicating one or more features of a Feature Combination associated with the RA procedure, a first preamble associated with the Feature Combination associated with the RA procedure, a number of consecutive preambles associated with the Feature Combination per Synchronization Signal/Physical broadcast channel block (SSB) a number of consecutive preambles per SSB which are associated with a preamble group for the Feature Combination, feature priorities, indicating priorities for the one or more features of the Feature Combination, an indication on whether a message 3 (Msg3) repetition is enabled per RA procedure, per beam or per RA attempt, a number of Msg3 repetitions per RA attempt or per beam, a modulation and coding scheme for the Msg3 repetition, a number of repetitions for a physical uplink shared channel transmission scheduled by an RA radio network temporary identifier uplink grant and downlink control information format 0_0, network slice related information associated with the RA procedure, at least one network slice group identity associated with the RA procedure, at least one backoff value associated with the RA procedure, at least one scaling factor associated with the at least one backoff value, an indication on whether backoff index is received for the RA procedure, at least one power ramping step used in the RA procedure, at least one purpose associated with the at least one power ramping step, an access identity associated with the RA procedure, an indication on whether the RA procedure is successful or not, an indication on whether DL RSRP is above the threshold configured for a Msg3 repetition selection or not per RA procedure or per RA attempt or per beam or per consecutive RA attempt in the same beam or per BWP, or the threshold used by the UE for determining whether to select resources indicating Msg3 repetition in this BWP.

Preferably, the one or more features of the Feature Combination associated with the RA procedure comprises at least one of: a reduced capability, a Msg3 repetition, a small data transmission, or a network slicing.

Preferably, the first preamble associated with the Feature Combination associated with the RA procedure is indicated by an integer with a value range from 1 to 64.

Preferably, the number of consecutive preambles associated with the Feature Combination per SSB is indicated by an integer with a value range from 1 to 64.

Preferably, the number of consecutive preambles per SSB which are associated with the preamble group for the Feature Combination is indicated by an integer with a value range from 1 to 64.

Preferably, each feature priority is indicated by an integer with a value range from 0 to 7.

Preferably, the number of Msg3 repetitions per RA attempt or per beam is indicated by: an integer with a range from 1 to 16, or at least one value in a value set.

Preferably, the modulation and coding scheme for the Msg3 repetition is indicated by an integer with a value range from 0 to 31.

Preferably, each network slice group identity is indicated by a bitstring.

Preferably, the at least one backoff value is indicated by at least one backoff index.

Preferably, each ramping step used in the RA procedure is indicated as a value in a value set.

Preferably, the RA information comprises information associated with the RA procedure in a shared spectrum.

Preferably, the RA information comprises at least one of: a configuration for detecting consistent uplink listen-before-talk (LBT) failures in a shared spectrum channel access, an indication of the RA procedure being initiated for LBT failure recovery, an indication of whether a LBT failure indication is received per RA attempt in the shared spectrum, a number of LBT failure indication received per beam or per consecutive attempt within one beam in the RA procedure or per RA procedure in the shared spectrum, an indication on whether the RA procedure in the shared spectrum is successful, an indication on whether a LBT recovery is successful, a number of transmission opportunities configured per bandwidth part for each RA procedure in the unlicensed spectrum, a running time of a timer associated with a LBT failure detection, a number of detected LBT failures per bandwidth part or per cell, or an indication of whether consistent LBT is detected in a bandwidth part.

Preferably, the configuration for detecting the consistent uplink LBT failures in the shared spectrum channel access comprises at least one of: a length of a timer for the consistent uplink LBT failure detection, or a maximum number of LBT failure indications received from a physical layer before triggering an uplink LBT failure recovery.

Preferably, the wireless communication method further comprises receiving, from the wireless network node, an RA configuration determined based on the RA information.

Preferably, the wireless communication method further comprises transmitting, to the wireless network node, a capability indication associated with reporting the RA information relevant to RA procedure utilizing RA resources associated with a Feature Combination of the RA procedure.

Preferably, the wireless communication method further comprises receiving, from the wireless network node, a request for the capability indication.

The present disclosure relates to a wireless communication method for use in a wireless network node. The method comprises receiving, from a wireless terminal, random access, RA, information of at least one RA procedure, and determining a RA configuration associated with the RA procedure of the wireless terminal.

Various embodiments may preferably implement the following features:

Preferably, the RA information comprises information associated with utilizing RA channel, RACH, resources associated with one or more features that are applicable for the RA procedure.

Preferably, the RA information of each RA procedure comprises at least one of: a feature type, indicating one or more features of a Feature Combination associated with the RA procedure, a first preamble associated with the Feature Combination associated with the RA procedure, a number of consecutive preambles associated with the Feature Combination per Synchronization Signal/Physical broadcast channel block (SSB) a number of consecutive preambles per SSB which are associated with a preamble group for the Feature Combination, feature priorities, indicating priorities for the one or more features of the Feature Combination, an indication on whether a message 3 (Msg3) repetition is enabled per RA procedure, per beam or per RA attempt, a number of Msg3 repetitions per RA attempt or per beam, a modulation and coding scheme for the Msg3 repetition, a number of repetitions for a physical uplink shared channel transmission scheduled by an RA radio network temporary identifier uplink grant and downlink control information format 0_0, network slice related information associated with the RA procedure, at least one network slice group identity associated with the RA procedure, at least one backoff value associated with the RA procedure, at least one scaling factor associated with the at least one backoff value, an indication on whether backoff index is received for the RA procedure, at least one power ramping step used in the RA procedure, at least one purpose associated with the at least one power ramping step, an access identity associated with the RA procedure, an indication on whether the RA procedure is successful or not, an indication on whether DL RSRP is above the threshold configured for a Msg3 repetition selection or not per RA procedure, or per RA attempt or per beam or per consecutive RA attempt in the same beam or per BWP, or the threshold used by the UE for determining whether to select resources indicating Msg3 repetition in this BWP.

Preferably, the one or more features of the Feature Combination associated with the RA procedure comprises at least one of: a reduced capability, a Msg3 repetition, a small data transmission, or a network slicing.

Preferably, the first preamble associated with the Feature Combination associated with the RA procedure is indicated by an integer with a value range from 1 to 64.

Preferably, the number of consecutive preambles associated with the Feature Combination per SSB is indicated by an integer with a value range from 1 to 64.

Preferably, the number of consecutive preambles per SSB which are associated with the preamble group for the Feature Combination is indicated by an integer with a value range from 1 to 64.

Preferably, each feature priority is indicated by an integer with a value range from 0 to 7.

Preferably, the number of Msg3 repetitions per RA attempt or per beam is indicated by: an integer with a range from 1 to 16, or at least one value in a value set.

Preferably, the modulation and coding scheme for the Msg3 repetition is indicated by an integer with a value range from 0 to 31.

Preferably, each network slice group identity is indicated by a bitstring.

Preferably, the at least one backoff value is indicated by at least one backoff index.

Preferably, each ramping step used in the RA procedure is indicated as a value in a value set.

Preferably, the RA information comprises information associated with the RA procedure in a shared spectrum.

Preferably, the RA information comprises at least one of: a configuration for detecting consistent uplink listen-before-talk (LBT) failures in a shared spectrum channel access, an indication of the RA procedure being initiated for LBT failure recovery, an indication of whether a LBT failure indication is received per RA attempt in the shared spectrum, a number of LBT failure indication received per beam or per consecutive attempt within one beam in the RA procedure or per RA procedure in the shared spectrum, an indication on whether the RA procedure in the shared spectrum is successful, an indication on whether a LBT recovery is successful, a number of transmission opportunities configured per bandwidth part for each RA procedure in the unlicensed spectrum, a running time of a timer associated with a LBT failure detection, a number of detected LBT failures per bandwidth part or per cell, or an indication of whether consistent LBT is detected in a bandwidth part.

Preferably, the configuration for detecting the consistent uplink LBT failures in the shared spectrum channel access comprises at least one of: a length of a timer for the consistent uplink LBT failure detection, or a maximum number of LBT failure indications received from a physical layer before triggering an uplink LBT failure recovery.

Preferably, the wireless communication method further comprises transmitting, to the wireless terminal, an RA configuration determined based on the RA information.

Preferably, the wireless communication method further comprises receiving, from the wireless terminal, a capability indication associated with reporting the RA information relevant to RA procedure utilizing RA resources associated with a Feature Combination of the RA procedure.

Preferably, the wireless communication method further comprises transmitting, to the wireless terminal, a request for the capability indication.

Preferably, the wireless communication method further comprises transmitting the RA information to at least one of another wireless network node, a core network or a network function.

The present disclosure relates to a wireless terminal. The wireless terminal comprises:
a communication unit, configured to report, to a wireless network node, random access (RA) information of at least one RA procedure.

Various embodiments may preferably implement the following feature:

Preferably, the wireless terminal further comprises a processor configured to perform any of the aforementioned wireless communication methods.

The present disclosure relates to a wireless network node. The wireless network node comprises:
a communication unit, configured to receive, from a wireless terminal, random access (RA) information of at least one RA procedure, and
a processor, configured to determine a RA configuration associated with the RA procedure of the wireless terminal.

Various embodiments may preferably implement the following feature:

Preferably, the processor is further configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of a procedure according to an embodiment of the present disclosure.

FIG. 3 shows a flowchart of a method according to an embodiment of the present disclosure.

FIG. 4 shows a schematic diagram of reporting capability information according to an embodiment of the present disclosure.

FIG. 5 shows a schematic diagram of reporting random access channel information according to an embodiment of the present disclosure.

FIG. 6 shows an example of a schematic diagram of a wireless terminal according to an embodiment of the present disclosure.

FIG. 7 shows an example of a schematic diagram of a wireless network node according to an embodiment of the present disclosure.

### DETAILED DESCRIPTION

In the present disclosure, an unlicensed spectrum may refer to a shared spectrum, and vice versa.

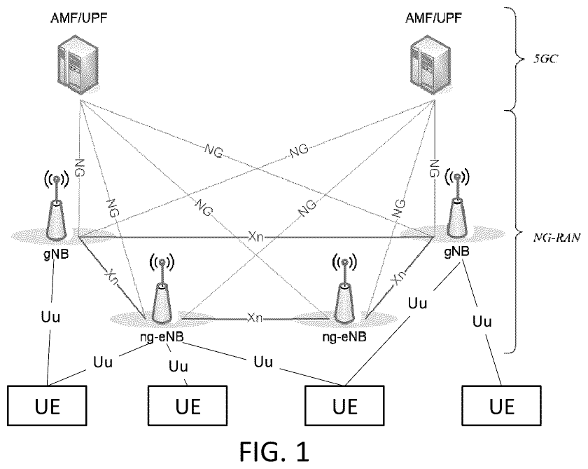

FIG. 1 shows a schematic diagram of a network (architecture) according to an embodiment of the present disclosure. In FIG. 1, the network comprises user equipments (UEs), next generation radio access network (NG-RAN) and a 5G core network (5GC). The 5GC is the Core network (CN) in New Radio (NR) and comprises various network entities and/or network functions, such as a session management function (SMF), an access and mobility management function (AMF), a user plane function (UPF), a policy control function (PCF), . . . , etc. FIG. 1 only shows AMFs and UPFs for illustrations. The NG-RAN comprises multiple base stations (BS) (or in other words RAN nodes), such as gNB and ng-eNB (next generation eNB) . . . etc. In FIG. 1, the UEs communicates with the NG-RAN (i.e., gNB and/or ng-eNB) via Uu interfaces and/or the 5GC via the NG-RAN. FIG. 1 only shows an example for a NR (new radio) architecture. Note that the method and devices disclosed in the present disclosure may also be applied to existing systems (e.g., LTE (long term evolution)) or a future system to be defined. For the LTE, the BS discussed can be an eNB or an en-gNB that is connected to LTE CN (e.g., EPC). In an embodiment, the UE may operate in a dual-connectivity (DC) and access two BSs, wherein one of the accessed BSs works as an MN (master node) and another one of the access BSs works as an SN (secondary node).

In the present disclosure, the NW (network) may refer to the BS or RAN node.

In the present disclosure, the UE may store RA information upon completing an RA procedure and report the stored RA information to the NW (e.g., BS) when being requested, to enable the RACH optimization. The BS receiving the RACH information may further forward the received RACH information to other relevant BSs (e.g. the BS where the UE initiates the RACH procedure) for optimization. As an alternative or in addition, the BS receiving the RACH information may share the RACH information between neighboring BS(s) to adjust the configuration of RACH resources to avoid conflict in the RACH resources. Furthermore, the BS receiving the RACH information may further forward the RACH information to another management system for optimizing the RACH configuration. The management system can be OAM (Operations, Administration and Maintenance) and/or TCE (Trace Collection Entity) and/or AMF (Access and Mobility Management Function) of a CN (Core Network) and/or another management system.

In the present disclosure, after the reception of RACH information reported from the UE, the NW and/or management system can optimize the RACH resource and/or access related configuration(s) to help improving the RACH performance or RACH capacity. Below are shown some examples on how the NW and/or the management system uses the RACH information for optimization. The use cases are not limited to the examples given in this disclosure. For example, the NW and/or the management system may optimize RACH resource division among different features. For example, the NW (or the management system) can adjust the priorities of different features. The NW (or the management system) can decide whether to configure additional RACH resources for certain features. The NW (or the management system) can change the RA resource division by adjusting starting preambles for different resource groups as well as the number of preambles assigned for each resource group. For example, the NW (or the management system) can assign more resources for a feature that has more needs to ease the RACH load. The NW (or the management system) can adjust the power ramping step and/or scaling factors for high priority features, to prioritize the RA procedure associated to the feature. That is NW (or the management system) can assign a smaller scaling factor and/or increase a power ramping step to improve a successful rate for features considered as high priorities. The NW (or the management system) can adjust the configuration for consistent LBT failure recovery, such as the maximum tolerant LBT failure time, the length of timer for consistent LBT failure detection (e.g., Ibt-FailureDetectionTimer) and etc.

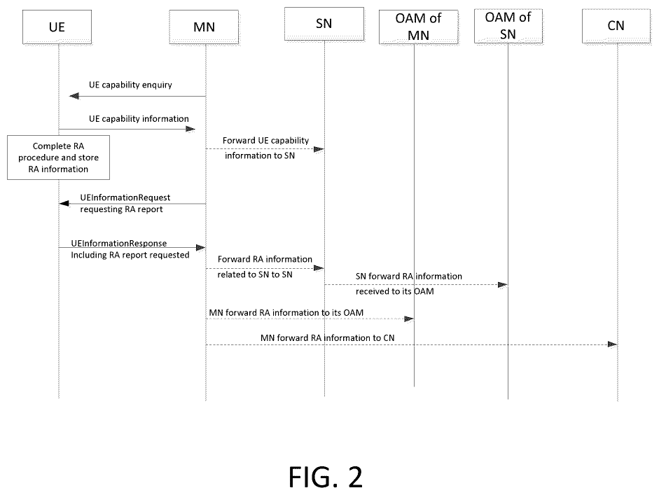

FIG. 2 shows a schematic diagram of a procedure according to an embodiment of the present disclosure. In FIG. 2, the UE operates in the DC, i.e., accessing to an MN and an SN. In this embodiment, the UE may report the collected RA information to the MN through a UEInformationRequest/UEInformationResponse procedure. After receiving the RACH information, the MN may further forward SN related RA information to the SN for optimization. In addition, the MN may forward the collected RACH information to its OAM (Operation, Administration and Maintenance) or CN for optimization. The SN may also forward the collected RACH information to its OAM for optimization. Please note that the listed operations in FIG. 2 may not be all necessary. That is some of the listed operations in FIG. 2 may be omitted. In other embodiments the RACH information can also be delivered to the MN through different RRC message(s). In some examples, the UE may report the RACH information relevant to SN to SN based on SN's request. Furthermore, to allow this behavior, the MN might need to forward the received UE capability information to SN.

In an embodiment, the UE may report RA information of each RAN node separately to each RAN node where being requested by the RAN node.

In an embodiment, the MN and SN in FIG. 2 may be a RAN node 1 and RAN node 2, there can be in Standalone or in DC. The RACH information can be forwarded to a management system. The management system may comprise at least one of OAM, AMF, TCE (Trace Collection Entity) or other function entity that used to optimize RACH configuration. Based on different deployments, the management system may only connect to the RAN node 1, the RAN node 2 or to both of them.

In some embodiments, the RA related information reported from the UE to the NW through one or more UE reports includes an RA report, an RLF (radio link failure) report, a CEF (connection establishment failure) report (or accessibility measurements), a successful HO (handover) report and a SCG (secondary cell group) failure information. The RA report/RLF report/CEF report/successful HO report is reported to the NW through UEInformationRequest or UEInformationResponseInformation.

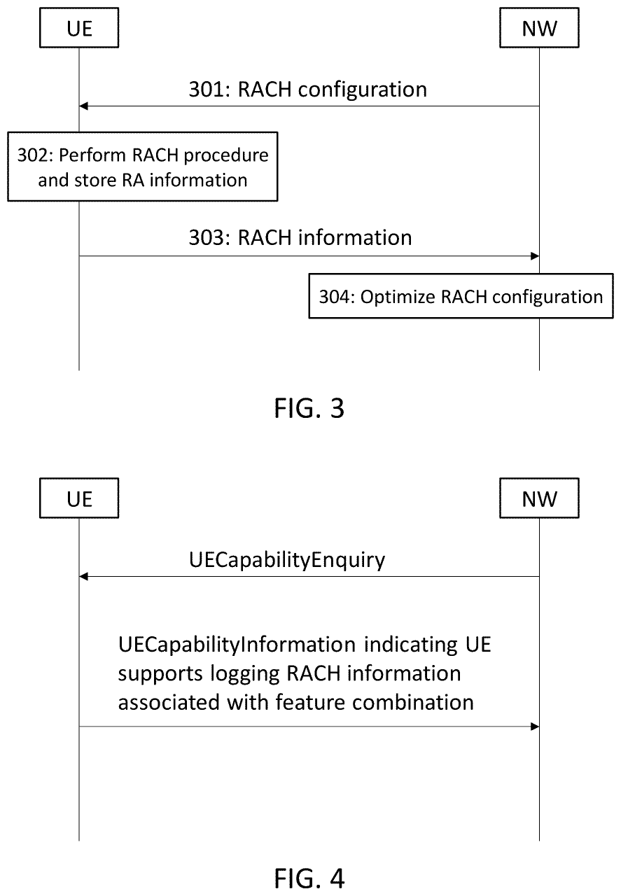

FIG. 3 shows a flowchart of a method according to an embodiment of the present disclosure. Specifically, in step 301, a UE receives RA configuration from an NW. In an embodiment, the RA configuration may include a configuration related to RA partition (e.g., RACH configuration comprising FeatureCombinationPreambles).

In step 302, the UE performs a RACH procedure and stores RA information in UE variable.

In step 303, the UE reports the RA information when requested by the NW.

In step 304, the NW optimizes the RACH configuration based on an analysis of the received RA report.

In the present disclosure, the RA information may be equaled to RACH information, or vice versa.

In some embodiments, the UE may report, to the NW, an availability of RA report (stored in its storage unit (e.g., memory)) to the NW through MAC (media access control) signaling (e.g., MAC CE (control element)) or RRC signaling after step 302, based on a capability of the NW on deciding whether to request UE to report the RA information or not.

In some embodiments, the NW may share/transmit the RACH information with another NW (e.g., another BS/gNB/NG-RAN) and/or the CN (e.g., network functions/entities in the CN).

Furthermore, if the UE performs the RACH procedure in an unlicensed spectrum, the stored RA information may further include information relevant to (the RACH procedure in) the unlicensed spectrum. In this case, the RA configuration of the UE may or may not include RA partition information.

In the present disclosure, the RACH procedure type can be a 2-step RA (procedure), a 4-step RA (procedure) or any type of RACH procedure.

In some embodiments, the RA information collecting and reporting can help the NW to optimize the RA resource division for different feature combinations and/or a LBT recovery configuration.

In an embodiment, a feature combination indicates a feature or a combination of features to be associated with a set of RA/RACH resources. The NW can associate a set of RACH resources with feature(s) applicable to an RA procedure: such as Network Slicing, RedCap (Reduced capability), SDT (small data transmission), and Msg3 repetition (or in other words NR (new radio) coverage enhancement). The set of RACH resources associated with one feature is only valid for the RA procedure(s) applicable to at least that feature; and the set of RACH resources associated with several features is only valid for the RA procedures having at least all of these associated features. The UE selects the set(s) of applicable RACH resources, after selecting uplink carrier (i.e., NUL or SUL) and BWP (bandwidth part) and before selecting the RA type.

For example, the RA information of a (completed) RA procedure collected and/or reported by the UE may include at least one of the following fields:
Feature type, indicating one or more of the types of Feature Combination associated with the RA procedure, wherein possible values of the Feature combination type may include a Msg3 repetition (or coverage enhancement (CE)), an SDT, RedCap, network slicing, and etc.,
The first preamble associated with the Feature Combination associated with this RA procedure,
The number of consecutive preambles associated with the corresponding Feature Combination starting from starting preamble(s) per SSB (Synchronization Signal/Physical broadcast channel (PBCH) block),
The number of consecutive preambles per SSB which are associated with a preamble group (e.g., Group A) and starts from the starting preamble(s) for the corresponding Feature Combination,
Feature priorities, indicating priorities for features, such as the RedCap, the Slicing, the SDT and MSG3-Repetitions for Coverage Enhancements,
Indication of whether 2-step RACH preambles identified by this FeatureCombinationPreambles are mapped to a PUSCH slot separated from the one defined in MsgA-ConfigCommon-r16 or not,
Indication on whether Msg3 repetition is enabled or not per RA procedure or per beam or per RA attempt or per consecutive RA attempt in the same beam,
Indication on whether DL RSRP is above the threshold configured for a Msg3repetition selection or not per RA procedure or per RA attempt or per beam or per consecutive RA attempt in the same beam or per BWP,
The threshold used by the UE for determining whether to select resources indicating Msg3 repetition in this BWP,
The number of Msg3 repetitions per RA procedure or per RA attempt or per beam or per consecutive RA attempt in the same beam or per BWP,
The number of Msg3 retransmissions per RA procedure or per RA attempt or per beam or per consecutive RA attempt in the same beam or per BWP,
MCS (modulation and coding scheme) used for Msg3 repetition,
The number of repetitions for PUSCH (physical uplink shared channel) transmission scheduled by RAR UL grant and DCI (downlink control information) format 0_0 with CRC (cyclic redundance check) scrambled by TC-RNTI (temporary cell radio network temporary identifier),
Slice related information,
Slice group identity,
Backoff value, which is used to indicate one or more backoff values utilized in this RA procedure,
Indication on whether BI has received for this RA attempt,
One or more power ramping step used for this RA procedure,
Access identity,
Indication of whether the ra-PrioritizationForSlicing/ra-PrioritizationForSlicingTwoStep should override ra-PrioritizationForAccessIdentity,
Indication of whether ra-Prioritization information applied for access identities,
The power offset between msg3 or msgA-PUSCH and RACH preamble transmission,
Indication on whether deltaPreamble is configured, or
NR-U related information.

In an embodiment, the RA information may further comprise additional information, e.g., other RA parameters.

For the mentioned parameters in this disclosure, when the parameter is set per beam, the beam type can be the SSB or the CSI-RS.

In an embodiment, the RA information of the (completed) RA procedure collected and/or reported by the UE may include at least one of the following fields:
Feature combination type, which can indicate one or more of the types of Feature Combination associated to this RA procedure,
The first preamble associated with the Feature combination associated with the RA procedure,
The number of consecutive preambles associated to the corresponding Feature Combination starting from the starting preamble(s) per SSB,
Indication on whether Msg3 repetition is enabled or not per RA procedure or per beam or per RA attempt,
Indication on whether DL RSRP is above the threshold configured for Msg3 repetition selection or not per RA procedure or per RA attempt or per beam or per consecutive RA attempt in the same beam or per BWP,
The threshold used by the UE for determining whether to select resources indicating Msg3 repetition in this BWP,
The number of Msg3 repetition per attempt, per beam,
MCS used for Msg3 repetition,
Slice group identity, or
Indication on whether BI has received for this RA attempt.

Note that, in this embodiment, the RA information may further include other aforementioned field(s) and/or RA parameters.

More details and embodiments of the aforementioned fields/parameters included in the RA information are illustrated in the following, e.g., via exemplified ASN.1 (Abstract syntax notation). Please note that embodiments given below are just exemplified examples and the aforementioned fields/parameter in the RA information may be carried in different ASN.1 format. Moreover, the terminology/name and/or the value range of each parameter discussed can also be modified to have different values from those given in the example.

In an embodiment, the Feature combination type, which indicate one or more of the types of Feature Combination associated to this RA procedure, may be implemented as:

FeatureCombination-rxx ::= SEQUENCE {

| | | |
|---|---|---|
| redCap-r17 | ENUMERATED | {true} OPTIONAL, |
| smallData-r17 | ENUMERATED | {true} OPTIONAL, |
| nsag-r17 | NSAG-List-r17 | OPTIONAL, |
| msg3-Repetitions-r17 | ENUMERATED | {true} OPTIONAL, |
| spare4 | ENUMERATED | {true} OPTIONAL, |
| spare3 | ENUMERATED | {true} OPTIONAL, |
| spare2 | ENUMERATED | {true} OPTIONAL, |
| spare1 | ENUMERATED | {true} OPTIONAL |

}
NSAG-List-r17 ::= SEQUENCE (SIZE (1.. maxSliceInfo-r17)) OF
NSAG-ID-r17

FeatureCombinationIndication field descriptions

redcap
If present, this field indicates that RedCap is part of this feature
combination.
smallData
If present, this field indicates that Small Data is part of this feature
combination.
nsag
If present, this field indicates NSAG(s) that are part of this feature
combination.
msg3-Repetitions
If present, this field indicates that signalling of msg3 repetition is part of
this feature combination.

As an alternative, the Feature combination type may be implemented as:

FeatureCombination-rxx ::= CHOICE {

| | | |
|---|---|---|
| redCap-r17 | ENUMERATED | {true} OPTIONAL, |
| smallData-r17 | ENUMERATED | {true} OPTIONAL, |
| nsag-r17 | NSAG-List-r17 | OPTIONAL, |
| msg3-Repetitions-r17 | ENUMERATED | {true} OPTIONAL, |
| spare4 | ENUMERATED | {true} OPTIONAL, |
| spare3 | ENUMERATED | {true} OPTIONAL, |
| spare2 | ENUMERATED | {true} OPTIONAL, |
| spare1 | ENUMERATED | {true} OPTIONAL |

}
NSAG-List-r17 ::= SEQUENCE (SIZE (1.. maxSliceInfo-r17)) OF
NSAG-ID-r17

FeatureCombinationIndication field descriptions

redCap
If present, this field indicates that RedCap is part of this feature
combination.
smallData
If present, this field indicates that Small Data is part of this feature
combination.
nsag
If present, this field indicates NSAG(s) that are part of this feature
combination.
msg3-Repetitions
If present, this field indicates that signalling of msg3 repetition is part of
this feature combination.

Note that the field in the Feature combination type may change be represented in Boolean Type. That is, for each feature/field/parameter, one indication is used to indicate whether the associated RA resource is used in this RA procedure and the indication is Boolean type, where bit value ‘1’ refers to that the feature is part of the feature combination associated to this RA procedure while bit value ‘0’ means that the feature is not part of the feature combination. Or vice versa

For example, the redcap-r17 in Feature combination type may be represented by using the Boolean type as: “redCap-r17 BOOLEAN OPTIONAL” in ASN.1 format.

In an embodiment, the first preamble associated with the Feature Combination of this RA procedure may be represented/indicated by an integer type. For example, a value range of the integer type representing the first preamble may be from 1 to 64. This parameter can be used to calculate the first preamble associated with the Feature Combination. For example, assuming the number of SSBs per PRACH Occasion is N. If N<1 the first preamble in each PRACH occasion is the one having the same index indicated by this field. If N>=1 in each PRACH occasion N blocks of preambles associated with the Feature Combination are define, each having a start index n·N_{preamble}^{total}/N+(the value indicate by this field). The N_{preamble}^{total} refers to the total number of preamble configured for this RA type.

In an embodiment, the number of consecutive preambles associated to the corresponding Feature Combination starting from the starting preamble(s) per SSB may be represented/indicated by an integer type. For instance, a value range of the integer type representing the number of consecutive preambles may be from 1 to 64.

In an embodiment, the number of consecutive preambles per SSB are associated to a preamble group (e.g., Group A) starting from the starting preamble(s) for the corresponding Feature Combination may be represented/indicated by an integer type. In this embodiment, a value range of the integer type may be from 1 to 64.

In an embodiment, the feature priorities, which is used to indicates priorities of features (e.g., RedCap, Slicing, SDT and/or MSG-3 Repetitions for Coverage Enhancement) associated with the RA procedure, may be represented/indicated by an integer type, e.g., having a value range from 0 to 7. The feature priorities are used to determine which FeatureCombinationPreambles the UE shall use when a feature maps to more than one FeatureCombinationPreambles. In the present disclosure, a lower value of a feature priority means a higher priority of the corresponding feature.

In an embodiment, the indication of whether the 2-step RACH preambles identified by the FeatureCombinationPreambles is mapped to a PUSCH slot separated from the one defined in MsgA-ConfigCommon-r16 may be represented/indicated by:
Enumerated type: For example, presence of this the enumerated type indication means that RACH preambles 2-step identified by this FeatureCombinationPreambles is mapped to a PUSCH slot separated from the one defined in MsgA-ConfigCommon-r16, absence means that the 2-step RACH preambles identified by this FeatureCombinationPreambles is not mapped to a PUSCH slot separate from the one defined in MsgA-ConfigCommon-r16; or
Boolean type: The bit value ‘1’ means that the 2-step RACH preambles identified by this FeatureCombinationPreambles is mapped to a PUSCH slot separate from the one defined in MsgA-ConfigCommon-r16, and the bit value ‘0’ mean that the 2-step RACH preambles identified by this FeatureCombinationPreambles is not mapped to a PUSCH slot separate from the one defined in MsgA-ConfigCommon-r16. Note that the meaning the bit values ‘1’ and ‘0’ may be exchanged.

In an embodiment, the indication on whether Msg3 repetition is enabled per beam or per RA attempt or per consecutive RA attempt in one beam or per RA procedure may be represented/indicated by:
Enumerated type: For example, the presence of the enumerated type indication means that the Msg3 repetition is used in this RA attempt or in this RA procedure, while the absence means that the Msg3 repetition is not used.
Boolean type: the bit value ‘1’ means that the Msg3 repetition is used for this RA attempt or in this RA procedure, while the bit value ‘0’ means that the Msg3 repetition is not used. As an alternative, the bit value ‘1’ means that the Msg3 repetition is not used for this RA attempt or in this RA procedure, while the bit value ‘0’ means that the Msg3 repetition is used for this RA attempt or in this RA procedure.

In an embodiment, the indication on whether DL RSRP is above a configured threshold for Msg3 repetition selection per beam or per RA attempt or per consecutive RA attempt in one beam or per RA procedure is included in the RA information and may be represented/indicated by:
Enumerated type: For example, the presence of the enumerated type indication means that the DL RSRP measured is above the threshold configured for Msg3 repetition selection in this RA attempt or in this RA procedure while the absence means that it is not.
Boolean type: the bit value ‘1’ means that the DL RSRP measured is above the threshold configured for Msg3 repetition selection for this RA attempt or in this RA procedure, while the bit value ‘0’ means that it is not. As an alternative, the bit value ‘1’ means that the DL RSRP measured is above the threshold configured for Msg3 repetition selection in this RA attempt or in this RA procedure, while the bit value ‘0’ means that it is not for this RA attempt or in this RA procedure.

In an embodiment, the threshold used by the UE for determining whether to select resources indicating Msg3 repetition in this BWP can be represented/indicated by the integer type. A possible value range can be from 0 to 127.

In an embodiment, the number of Msg3 repetitions per RA attempt or per beam or per RA procedure which indicate the number of repetitions for PUSCH transmission scheduled by RAR UL grant and DCI format 0_0 with CRC scrambled by TC-RNTI may be represented/indicated by:
Integer type: A possible value of the integer type indication may be from 1 to 16.
Enumerated type: possible values of the enumerated type indication may be {n1, n2, n3, n4, n7, n8, n12, n16}; or
A series of integers: an example of the indication of series of integers is illustrated as the following ASN.1 format:

| | |
|---|---|
| numberOfMsg3-RepetitionsList-r17 | SEQUENCE (SIZE (4)) OF |
| NumberOfMsg3-Repetitions-r17, | |
| NumberOfMsg3-Repetitions-r17 ::= | ENUMERATED {n1, n2, n3, n4, n7, |
| n8, n12, n16} | |

In an embodiment, the number of Msg3 retransmissions per beam or per attempt or per consecutive attempt in one beam or per RA procedure indicate the number of Msg3 retransmission times per beam or per attempt or per consecutive attempts in one beam or per RA procedure. The beam type can be the SSB and/or the CSI-RS (channel state information reference signal).

In an embodiment, the MCS used for Msg3 repetition(s) for this RA attempt or per consecutive RA attempt in one beam or per RA procedure may be represented/indicated by
Integer type indication: The value range of this integer type indication may be from 0 to 31.

In an embodiment, the MCS used for Msg3 repetition(s) can be set per RA procedure, per beam, per RA attempt or per consecutive RA attempts in the same beam. The beam type can be SSB and/or CSI-RS.

In an embodiment, the slice group identity may be represented/indicated by:
a bitstring: For example, the bitstring indicates the slice group identity on which the RA procedure is initiated. In an embodiment, the slice group identity can be present by a bitstring of 8 bits-size, e.g., NSAG-ID-r17::=BIT STRING (SIZE (8)); or
a list of bitstrings: The list of bitstrings indicates a list of slice groups associated with the RA resource used in this RA procedure. Each group identity of the slice groups may have the format as indicated in above alternative of bitstring (e.g., NSAG-ID-r17::=BIT STRING (SIZE (8))).

In an embodiment, the Backoff value (field/parameter) includes one or more backoff values utilized in this RA procedure. During the RA procedure, in case of resource congestion, the UE may receive RA response(s) containing backoff index (BI) which correspondent to a backoff value. The UE delays the next RA attempt by a time period equals to the time indicated by this backoff value. In addition, if the UE is configured with prioritization parameters which include a scaling factor for the BI, the actual delay time is determined to be a product of the backoff value indicated by the received BI and the scaling factor (i.e., (backoff value)×(scaling factor)). For example, the BI and the correspondent backoff values may be indicated as the following Table I:

TABLE I
Backoff Parameter values.

| | Backoff Parameter value |
|---|---|
| Index | (ms) |
| 0 | 5 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | 1920 |
| 14 | Reserved |
| 15 | Reserved |

In an embodiment, in one RA procedure, one or more backoff values may be utilized. Thus, the backoff values utilized in RA procedure may be represented/indicated by:
Actual backoff values included per RA attempt, or
Received Backoff index included per RA attempt, which is optional present if backoff is received for this RA attempt. In addition, the UE may include a scaling factor if the scaling factor is utilized in this RA procedure.

In an embodiment, different IEs (information elements) are used to indicate the scaling factor utilized per RA procedure separately for 2-step and 4-step RA (procedure) types. Because the NW may separately configure the scaling factor for the BI for 2-step and/or 4-step RA resources and the UE may switch the RA type during one RA procedure, the UE may set different scaling factors for different RA types. Therefore, in this embodiment, different IEs are used to indicate the scaling factors utilized per RA procedure separately for 2-step and 4-step RA types. For example, the IE may be an enumerated type with possible values [0, 0.25, 0.5, 0.75]. Note that other values are still possible for different scenarios. An example of the IE in this embodiment is given as below:

| | | |
|---|---|---|
| scaling FactorBI-TwoStepRA | ENUMERATED {zero, dot25, dot5, dot75} | OPTIONAL, |
| scalingFactorBI-FourStepRA | ENUMERATED {zero, dot25, dot5, dot75} | OPTIONAL, |

In an embodiment, the NW may configure the UE with different scaling factors for dedicated resources and/or for beam failure recovery (BFR) configuration and/or for different slice groups. To indicate whether the used scaling factor is specific configured for certain type of UE/certain RA purpose/certain (network) Slice, the following option may be considered:
Different IEs are used to present the scaling factors separately configured for different purposes. and the differentiation between IEs for different scaling factors is done by using different IE names. For example, if the UE sets a scaling type with the value configured specifically for the BFR, the UE includes scalingFactorBIBFR which could have the same format as given in the above example for the scaling factors utilized per RA procedure. In addition, a list of one-bit indications may be additionally included in the IE, where each bit (indication) indicates if the scaling factor used is configured specifically for certain purpose. The purpose can be for the BFR, for the network slicing, for the reconfiguration with synchronization, . . . , etc. An example of the IEs for indicating the scaling factors configured for different purposes is given below:

ScallingFactorBIPurpose-rxx ::= CHOICE {

| | | |
|---|---|---|
| BFR-rxx | ENUMERATED | {true} OPTIONAL, |
| ReconfigurationWithSync-rxx | ENUMERATED | {true} OPTIONAL, |
| Slicing-rxx | ENUMERATED | {true} OPTIONAL, |
| spare 1 | ENUMERATED | {true} OPTIONAL |
| } | | |

Taking the IE for the BFR as an example, the indication is used to indicate whether the scaling factor used is specifically configured for the BFR or not. The indication can be present by either BOOLEAN type or Enumerate type as shown in above example. If the Boolean type is used, the bit value “1” means that the scaling factor is configured specific for BFR and the bit value “0” means the opposite. If the enumerate type is used, the presence of this indication (which is indicated by enumerate {true}) means the scaling factor is configured specific for BFR and the absence of this indication means the opposite. The similar logic applies to the reconfiguration with sync (synchronization) and slicing as well.

Note that the indication associated with the scaling factor (i.e., ScallingFactorBIPurpose-rxx) may change to be implemented by a sequence type other than the choice type shown in above examples. In addition, the IEs indicating the scaling factors for different types of RA (procedure) and the IEs indicating the scaling factors for certain purpose may be simultaneously used in some embodiments.

In an embodiment, the UE includes the BI indication per RA attempt, which indicates whether the BI is received in an RA response for this RA attempt or not, in the RA information. In addition, the UE includes the BI index received per RA procedure as well as the utilized scaling factor. The BI index may be presented by an integer type (indication) with a value range from 0 to 15. The format to indicate the scaling factor may reuse the above exemplified IEs associated with the scaling factor. The BI indication per RA attempt may be presented by either the BOOLEAN type or the enumerate type. If the Boolean type is used, the bit value “1” indicates that the BI is received in random access response for the RA attempt while the bit value “0” means the opposite. If the enumerate type is used, the presence of this indication (which is indicated by enumerate {true}) means that the BI is received in random access response for this RA attempt and the absence of this indication means the opposite.

In an embodiment, the BI indication can be set per RA procedure, per beam, per RA attempt or per consecutive RA attempts in the same beam. The beam type can be SSB and/or CSI-RS.

In some embodiments, the UE may be configured with different power ramping steps and the UE may utilize different power ramping steps in one RA procedure. Thus, the UE may include information of the used power ramping step(s) in the RA information. The following methods may be considered to indicate the power ramping step(s) used in the RA procedure.

In an embodiment, different IEs are used to indicate the power ramping step(s) utilized per RA procedure separately for 2-step and 4-step RA types. For example, the IE can be an enumerated type with possible values [0, 2, 4, 6] in the unit dB. Note that, other values remain possible for the IE. An example of the IE indicating the power ramping step(s) utilized per RA procedure is given as below:

| | | |
|---|---|---|
| powerRampingStep-TwoStepRA | ENUMERATED {dB0, dB2, dB4, dB6} | OPTIONAL, |
| powerRampingStep-FourStepRA | ENUMERATED {dB0, dB2, dB4, dB6} | OPTIONAL, |

Similar to the BI (field), different power ramping steps can be configured separately for different purposes, such as for the BFR, for the reconfiguration with sync and/or for different network slicing groups. Therefore, additional information may be considered to allow the NW to know if the reported power ramping step is for certain purpose(s). Thus, below embodiments can be considered.

In an embodiment, different IEs may be used to present the power ramping steps configured for different purpose separately and the differentiation between the IEs is done by using different IE names. For example, if the UE sets the power ramping step with a value configured specifically for the BFR, the UE includes an IE powerRampingStepBFR which could have the same format as given in above example for the power ramping step.

In another embodiment, a list of one-bit indications can be further included, where each bit indicates whether if the power ramping step used for the RA procedure is configured specifically for certain purpose(s). The purpose(s) can be for the BFR, for the (network) slicing, for the reconfiguration with sync, and etc.

An example for the IE indicating the power ramping step used for the RA procedure is given below:

powerRampingStepPurpose-rxx ::= CHOICE {

| | | |
|---|---|---|
| BFR-rxx | ENUMERATED {true} | OPTIONAL, |
| ReconfigurationWithSync-rxx | ENUMERATED {true} | OPTIONAL, |
| Slicing-rxx | ENUMERATED {true} | OPTIONAL, |
| spare1 | ENUMERATED {true} | OPTIONAL |
| } | | |

Note that, both the aforementioned embodiments of the IE indicating the power ramping step used for the RA procedure (i.e., different IEs for different power ramping steps for different purposes and the list of one-bit indications for different power ramping steps for different purposes) may be used together in an embodiment.

In an embodiment, the information of the used power ramping step(s) in the RA information can be set per RA procedure, per beam, per RA attempt or per consecutive RA attempts in the same beam. The beam type can be SSB and/or CSI-RS.

In an embodiment, the access identity (field) indicates the access identities associated with this RA procedure. The access identity (field) may be the integer type (indication) with a value range from 1 to n.

In an embodiment, the indication whether or not the ra-PrioritizationForSlicing/ra-PrioritizationForSlicingTwoStep should override the ra-PrioritizationForAccessIdentity in the RA procedure is included in the RA information of the RA procedure. The indication can be either the Boolean type or the enumerate type. In the embodiment of the Boolean type, the bit value “1” may indicate that the prioritization parameters from the ra-PrioritizationForSlicing/ra-PrioritizationForSlicingTwoStep overrides those in the ra-PrioritizationForAccessIdentity and are used in this RA procedure, while the bit value “0” means the opposite. Or vice versa. In the embodiment of the enumerate type, the presence of such indication (i.e., enumerate {true}) indicates that the prioritization parameters are overridden while the absence of the indication means the opposite.

In an embodiment, the power offset between the msg3 or msgA-PUSCH and the RACH preamble transmission in the RA procedure is included in the RA information of the RA procedure.

In an embodiment, the indication on whether deltaPreamble is configured or not is included in the RA information of the RA procedure. The indication can be either the Boolean type or the enumerate type. In the embodiment of the Boolean type, the bit value “1” may indicate that deltaPreamble is configured and the bit value “0” means that deltaPIreamble is not configured. Or, vice versa. In the embodiment of the enumerate type, the presence of such indication (i.e., enumerate {true}) indicates that deltaPreamble is configured and the absence of the indication means the opposite.

In an embodiment, the UE stored and/or reported RA information may also include NR-U related information. For example, the NR-U related information may include at least one of the following:
(a) Configuration of LBT failure related information:

In an embodiment, the Configuration of LBT failure related information may be implemented as the following LBT-FailureRecoveryConfig-r16 in the ASN.1 format for:

LBT-FailureRecoveryConfig-r16 ::= SEQUENCE {

| | |
|---|---|
| lbt-FailureInstanceMaxCount-r16 | ENUMERATED {n4, n8, n16, n32, n64, n128}, |
| lbt-FailureDetectionTimer-r16 | ENUMERATED {ms10, ms20, ms40, ms80, |
| ms160, ms320}, | |
| ... | |
| } | |

(b) Information indicating that the RA procedure is initiated to perform recovery from consistent LBT failure:

For example, this information may be implemented as the following raPurpose(−r16) in the ASN.1 format:

raPurpose-r16 ENUMERATED {accessRelated, beamFailureRecovery,
reconfigurationWithSync, ulUnSynchronized, schedulingRequestFailure,
noPUCCHResourceAvailable, requestForOtherSI, msg3RequestForOtherSI-r17,
lbtFailureRecovery-rxx, spare7, spare6, spare5, spare4, spare3, spare2, spare1}

In an embodiment, the UE sets the raPurpose(−r16) as IbtFailureRecovery if the RA procedure is performed for the consistent LBT failure recovery.

In an embodiment, the UE sets raPurpose(−r16) as consistentLBTFailure when a consistent LBT failure indication is triggered in SpCells (special cells).

Furthermore, in some embodiments, it is beneficial to further clarify on whether the RA (procedure) is triggered due to lack of PUCCH resources for an SR (scheduling request) of requesting UL resources for an LBT failure MAC CE. In an embodiment, the UE sets the raPurpose as noPUCCHResourceAvailable. As an alternative, the UE sets the raPurpose as the consistentLBTFailure if the SR is for transmitting LBT failure MAC CE. In addition, an additional bit may be introduced to indicate that the SR is for transmitting LBT failure MAC CE or not in the case that the raPurpose is set to noPUCCHResourceAvailable or SRFailure. By introducing the additional bit, the NW can avoid missing the LBT failures triggered in SCells (secondary cells) if the UE sets the raPurpose as noPUCCHResourceAvailable when the RA (procedure) is triggered due to lack of the PUCCH resources and can correctly acknowledge whether the RA is triggered due to lack of the PUCCH resources. Note that the indication bit may also be applied for the BFR in the SCell.

In an embodiment, one bit may be introduced to indicate whether the SR is for transmitting LBT Failure MAC CE or not, which is optionally presented when raPurpose is set to noPUCCHResourceAvailable or SRFailure. The bit is set to “1” when the SR is for the LBT failure MAC CE transmission, otherwise the bit is set to “0”. Or vice versa.

In an embodiment, one bit may be introduced to indicate whether the SR is for transmitting the BFR MAC CE (or truncated BFR MAC CE), which is optionally presented when raPurpose is set to noPUCCHResourceAvailable or SRFailure. The bit is set to “1” when the SR is for the BFR MAC CE (or truncated BFR MAC CE) transmission, otherwise the bit is set to “0”. Or vice versa.

As an alternative, one field (e.g., srPurpose) may be introduced in the RA information/report of the RA procedure to indicate whether the SR is for the BFR MAC CEs or for the LBT failure MAC CEs. This field can be selected among {BFR, consistentLBTFailure}. Furthermore, the filed may also include certain spared bits for future extension.
(c) LBT failure indication per RA attempt to indicate whether LBT failure indication is received from PHY layer per RA attempt:

In an embodiment, the LBT failure indication may be implemented by:
Boolean type: The bit value “1” means that at least one LBT failure indication has been received from a lower layer for this RA attempt and the bit value “0” means the opposite.
Enumerate type: For example, the presence of the LBT failure indication (i.e., enumerate {true}) means that at least one LBT failure indication has been received from a lower layer for this RA attempt and the absence of the LBT failure indication implies that no LBT failure indication is received for this RA attempt.

In an embodiment, the LBT failure indication can be set per RA procedure, per beam, per RA attempt or per consecutive RA attempts in the same beam. The beam type can be SSB and/or CSI-RS.

In an embodiment, instead including this LBT failure indication per RA attempt, the UE includes the LBT failure indication per consecutive RA attempts in one beam, wherein the beam type can be either CSI-RS (channel state information reference signal) or SSB. The LBT failure indication in this embodiment may be designed as the LBT failure indication per RA attempt.

In an embodiment, the LBT failure indication can be set per RA procedure, per beam, per RA attempt or per consecutive RA attempts in the same beam. The beam type can be SSB and/or CSI-RS.

In this embodiment, because the UE does not transmit the preamble when the LBT failure indication is received, it remains ambiguous that whether each reception of LBT failure is counted as an RA attempt if the preamble is not transmitted. Thus, the LBT failure indication per (consecutive) RA attempt(s) is introduced. In an embodiment, an IE perRA-InfoList may be included in the RA related information per RA attempt (i.e., per preamble transmission if the NR-U is not considered), where the maximum size of perRA-InfoList equals to the maximum transmission time (e.g., 200). Since the LBT failure indication does not increase the transmission counter, the maximum size of perRA-InfoList may be increased to a sum of the maximum transmission time and the maximum LBT failure time (e.g., 200+128=328), so as to support the LBT failure indication per RA attempt. In an embodiment, the UE may count the number of LBT failure indication received from the lower layer per beam or in the basis of current RA structure, per consecutive attempts within one beam.
(d) The number of LBT failure indications received per beam (SSB or CSI-RS) or per consecutive attempts within one beam (e.g., SSB or CSI-RS) in one RA procedure:

In an embodiment, the integer type can be used to indicate this information and the value range can be from 1 to n. An example is given below in ASN.1 format:

| | | |
|---|---|---|
| numberOfLBTFailure ReceivedOnSSB | INTEGER (1..n), | OPTIONAL; |
| numberOfLBTFailureReceivedOnCSI-RS | INTEGER (1..n), | OPTIONAL; |

(e) Indication on whether the RA procedure is successful or not:

In an embodiment, this indication is implemented by using the Boolean type (indication), where the bit value “1” means that the RA procedure is successful and the bit value “0” means the RA procedure fails.

As an alternative, the enumerate type can be used to indicate whether RA procedure is successful or not. For example, the UE includes the indication setting to enumerate {true} means that the RA procedure is successful, otherwise this indication is absent, which implies the RA procedure fails.

As still another alternative, an indication is used to indicate whether the RA fails or not. The UE only includes this indication when the RA procedure fails otherwise this indication is absence, which implies the RA is successful.
(f) Indication of whether LBT recovery is successful or not

In an embodiment, the indication of whether the LBT recovery is successful may be implemented as the indication for indicating whether the RA procedure is successful.
(g) Time since the latest LBT failure to the latest RA attempt (for each RA attempt):

In an embodiment, this information may be implemented as an integer type (indication) with a value ranged from 0 to n ms (milliseconds).
(h) Time from the LBT failure to next available transmission occasion:

In an embodiment, this information may be an integer type (indication) with a value ranged from 0 to n ms.
(i) The number of the LBT failures detected per RA procedure or during a logging period or during a sampling period. In an embodiment, the number of the LBT failures can be set per RA procedure, per beam, per RA attempt or per consecutive RA attempts in the same beam. The beam type can be SSB and/or CSI-RS.
(j) Time since the last LBT failure to the latest BWP switch:

This information indicates the time elapse from the last detected LBT failure indication to the latest BWP switch. In an embodiment, the information can be an integer type (indication) with a value ranged from 0 to n ms.
(k) The number of transmission opportunities for each RA resource configured per BWP.
(l) Running time of Ibt-FailureDetectionTimer:

This information indicates the running time of lbt-FailureDetectionTimer until completion of this RA procedure.
(m) The number of LBT failure detected (e.g., LBT_COUNTER):

In an embodiment, a granularity of this information may be per BWP and/or per cell.
(n) Maximum tolerant LBT failure number:

In an embodiment, the maximum tolerant LTB failure number/times is configured by lbt-FailureInstanceMaxCount.
(o) Indication of whether a consistent LBT failure is detected in this BWP or not:

In an embodiment, the indication may be included in the RA information of the RA procedure as:
Boolean type: where the bit value “1” means that the consistent LBT failure is detected in this BWP and the bit value “0” means the opposite. Or, vice versa.
Enumerate type: For example, the UE includes the indication setting to enumerate {true} means that the consistent LBT failure is detected in this BWP, otherwise this indication is absent, which implies that the consistent LBT failure is not detected in this BWP.

When adopting a new function or enhance an existing function for further optimization, there could be additional requirement on the UE. Moreover, the NW may also need to know which function is supported by the UE, so that the NW can act accordingly.

In an embodiment, for logging of the feature combination information in the RACH resource, the following embodiments may be considered to indicate the UE capability.

### (1) Optional With Capability Signaling

In this embodiment, logging of RA report associated to features listed in the feature combination is optional for the UE. In addition, one indication is used to indicate the NW that if UE supports logging of RA report associated to features listed in feature combination or not, e.g., in UECapabilityInformation shown in FIG. 4. Note that the NW may transmit a UEcapabilityEnquiry to the UE, to request the indication.

An example for signaling is given in below:

— SON-Parameters
The IE SON-Parameters contains SON related parameters.
SON-Parameters information element
-- ASN1START
-- TAG-SON-PARAMETERS-START
SON-Parameters-r16 ::= SEQUENCE {
[unrelated part omitted]
featureCombinationRACH-Report-rxx ENUMERATED {supported} OPTIONAL
]]
}
-- TAG-SON-PARAMETERS-STOP
-- ASN1STOP

| | | | FDD- | FR1- |
|---|---|---|---|---|
| | | | TDD | FR2 |
| Definitions for parameters | Per | M | DIFF | DIFF |
| featureCombinationRACH-Report-rxx | UE | No | No | No |
| Indicates whether the UE supports RACH report | | | | |
| associated to features listed in feature | | | | |
| combination (e.g., SDT, CE, RedCap and Slicing) | | | | |
| upon request from the network. | | | | |

Note that the field “M” in the above table indicates that whether the corresponding parameter is mandatory, the field “FDD-TDD DIFF” indicates that whether the corresponding parameter needs a differentiation in FDD (Frequency-Division Duplex) and in TDD (Time-Division Duplex), and the field “FR1-FR2 DIFF” indicates that whether the corresponding parameter needs a differentiation in FR1 (Frequency Range 1) and FR2 (Frequency Range 2).

In an embodiment of dual-connectivity (DC), an MN (master node) might forward the received UE capability information to a SN (secondary node), so that the SN can know the UE capability information as well.

### (2) Optional Without Capability Signaling

In this embodiment, the logging of RA report associated to features listed in feature combination is optional for UE. Note that, the UE does not need to signal the capability to the NW in this embodiment.

### (3) Conditional Mandatory

If UE supports at least one of the features indicated in feature combination, and UE supports 4step and/or 2step RA report, UE supports logging of RA report associated to features listed in feature combination.

In an embodiment of the RA information comprising the NR-U related information, the following embodiments may be considered to indicate the UE capability for logging of NR-U related information:

### (1) Optional With Capability Signaling

In this embodiment, the logging of RA report initiated on unlicensed spectrum is optional for UE. In addition, one indication (e.g., in UECapabilityInformation shown in FIG. 4) is used to indicate to the NW that whether the UE supports logging of RA report initiated on unlicensed spectrum.

As an alternative or in addition, the logging of RA report initiated for the (consistent) LBT failure recovery is optional for UE and one indication is used to indicate to the NW that whether UE supports the logging of RA report initiated for the LBT recovery.

The following signaling bit design in ASN.1 format shows some exemplified examples for this embodiment:

— SON-PARAMETERS
The IE SON-Parameters contains SON related parameters.
SON-Parameters information element
-- ASN1START
-- TAG-SON-PARAMETERS-START
SON-Parameters-r16 ::= SEQUENCE {
[unrelated part omitted]
unlicensedRACH-Report-rxx ENUMERATED {supported} OPTIONAL
]]
}
-- TAG-SON-PARAMETERS-STOP
-- ASN1STOP

| | | | FDD- | FR1- |
|---|---|---|---|---|
| | | | TDD | FR2 |
| Definitions for parameters | Per | M | DIFF | DIFF |
| unlicensedRACH-Report-rxx | UE | No | No | No |
| Indicates whether the UE supports RACH report | | | | |
| initiated on unlicensed spectrum upon request | | | | |
| from the network | | | | |

As an alternative:

| | | | FDD- | FR1- |
|---|---|---|---|---|
| | | | TDD | FR2 |
| Definitions for parameters | Per | M | DIFF | DIFF |
| unlicensedRACH-Report-rxx | UE | No | No | No |
| Indicates whether the UE supports RACH report | | | | |
| initiated for consistent LBT failure recovery upon | | | | |
| request from the network | | | | |

Note that the field “M” in the above table indicates that whether the corresponding parameter is mandatory, the field “FDD-TDD DIFF” indicates that whether the corresponding parameter needs a differentiation in FDD and in TDD, and the field “FR1-FR2 DIFF” indicates that whether the corresponding parameter needs a differentiation in FR1 and FR2.

In case of DC, the MN might forward the received UE capability information to the SN, to inform the SN the UE capability information.

### (2) Optional Without Capability Signaling

In this embodiment, the logging of RA report initiated on unlicensed spectrum is optional for UE and the UE does not need to signal the capability to the NW.

As an alternative or in addition, the logging of RA report initiated for the LBT recovery is optional for UE and the UE does not need to signal the capability to the NW.

### (3) Conditional Mandatory

In an embodiment, if the UE supports operations on the unlicensed spectrum and supports 4-step and/or 2-step RA report, the UE supports the logging of RA report initiated on the unlicensed spectrum.

As an alternative or in addition, if the UE supports operation on unlicensed spectrum and supports 4-step and/or 2-step RA report, the UE supports logging of RA report initiated for the consistent LBT recovery.

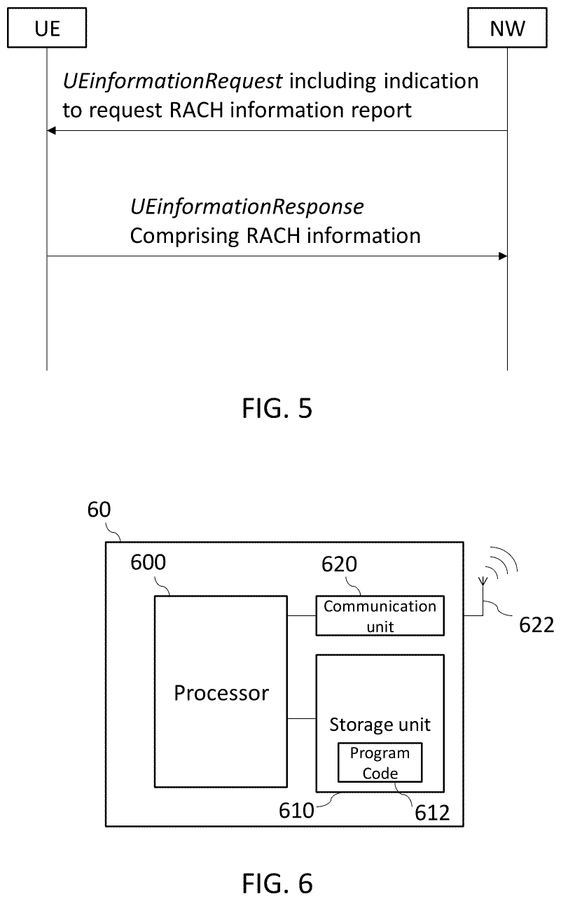

FIG. 5 shows a schematic diagram of reporting the RA information according to an embodiment of the present disclosure. In FIG. 5, the NW transmits UEInformationRequest to the UE, wherein the UEInformationRequest includes indication associated with requesting RACH information report. The UE transmits UEInformationResponse comprising RACH information to the NW.

In some embodiments, single RA report may include one or multiple RA entries, where each RA entry is used to include RA information related to one completed RA procedure. In an embodiment, the RA report may only include the RA information belonging to successful completed RA procedure(s) while the RA information belonging to unsuccessful completed RA procedure(s) is included either in an RLF (radio link failure) report or a CEF (connection establishment failure) report or SCG failure information. The RACH information may also be carried in a successful Handover report of MN or SN. As an alternative, the RA report includes the RA information of all RA procedure regardless of whether each RA procedure is successfully completed or not. The maximum number of RA entries included in one RA report may be pre-defined in protocol or configured by the NW.

In an embodiment, the RA report comprising the RA information related to the NR-U may be separated from that related to the remaining parameters. A separate report may be defined to include NR-U related information for optimization purpose, the NR-U related information could include the NR-U related RACH information as discussed in this disclosure. Furthermore, when a separate report is defined, a separate request bit may also be defined to request reporting of the report carrying NR-U related RACH information. In addition, in some examples, an availability bit can be used to indicate the availability of NR-U related RACH information at the UEs side that can be request by the NW.

In an embodiment, a separate RA report may also be defined for collecting RACH partition information (e.g., to collect information on RACH procedure that associated to feature combination). Furthermore, when a separate report is defined, a separate request bit may also be defined to request reporting of the report carrying RACH partition information. In addition, in some examples, an availability bit can be used to indicate the availability of RACH partition information at the UE's side that can be requested by the NW.

That is there may be a type of RA report designed for carrying RA information associated with the NR-U and/or RACH partition information (e.g., RACH information associated to Feature Combination).

In an embodiment, the RACH information may be carried on other existing RRC message or new defined RRC messages.

In the following example, the IEs which may be used for signaling the RACH information are illustrated in the ASN.1 format. Note that the following IEs are just exemplified examples and the RA information can also be carried in the IEs having different ASN.1 format. And in other examples, the location of IEs can be different. In addition, it is possible that only one or more of the IEs listed in the following example are implemented. Moreover, the terminology/name or the value range of each IE can also be modified. Also, different IEs (e.g., the parameters discussed in this disclosure) can also be included.

### EXAMPLE

In this example the RACH information is reported via UEInformationResponse message as shown in FIG. 4.
UEInformationResponse
UEInformationResponse

The UEInformationResponse message is used by the UE to transfer information requested by the network.

Signaling radio bearer: SRB1 or SRB2 (when logged measurement information is included)

| RLC-SAP: AM | | |
|---|---|---|
| Logical channel: DCCH | | |
| Direction: UE to network | | |
| | UEInformationResponse message | |
| -- ASN1START | | |
| -- TAG-UEINFORMATIONRESPONSE-START | | |
| UEInformationResponse-r16 ::= | SEQUENCE { | |
| rrc-TransactionIdentifier | RRC-TransactionIdentifier, | |
| criticalExtensions | CHOICE { | |
| ueInformationResponse-r16 | UEInformationResponse-r16-IEs, | |
| criticalExtensionsFuture | SEQUENCE { } | |
| } | | |
| } | | |
| UEInformationResponse-r16-IEs ::= | SEQUENCE { | |
| measResultIdleEUTRA-r16 | MeasResultIdleEUTRA-r16 | OPTIONAL, |
| measResultIdleNR-r16 | MeasResultIdleNR-r16 | OPTIONAL, |
| logMeasReport-r16 | LogMeasReport-r16 | OPTIONAL, |
| connEstFailReport-r16 | ConnEstFailReport-r16 | OPTIONAL, |
| ra-ReportList-r16 | RA-ReportList-r16 | OPTIONAL, |
| rlf-Report-r16 | RLF-Report-r16 | OPTIONAL, |
| mobilityHistoryReport-r16 | MobilityHistoryReport-r16 | OPTIONAL, |
| lateNonCriticalExtension | OCTET STRING | OPTIONAL, |
| nonCriticalExtension | UEInformationResponse-v1700-IEs | |
| OPTIONAL | | |
| } | | |
| [Some IEs omitted] | | |

RA-ReportList-r16 ::= SEQUENCE (SIZE (1..maxRAReport-r16)) OF RA-Report-r16

| RA-Report-r16 ::= | SEQUENCE { | |
|---|---|---|
| cellId-r16 CHOICE { | | |
| cellGlobalId-r16 | CGI-Info-Logging-r16, | |
| pci-arfcn-r16 | PCI-ARFCN-NR-r16 | |
| }, | | |
| ra-InformationCommon-r16 RA-InformationCommon-r16 | | OPTIONAL, |
| raPurpose-r16 | ENUMERATED {accessRelated, | |

beamFailureRecovery, reconfigurationWithSync, ulUnSynchronized, schedulingRequestFailure,
noPUCCHResourceAvailable, requestForOtherSI, msg3RequestForOtherSI-r17,
lbtFailureRecovery-rxx, spare7, spare6, spare5, spare4, spare3, spare2, spare1},

| | | |
|---|---|---|
| ..., | | |
| [[ | | |
| spCellID-r17 | CGI-Info-Logging-r16 | OPTIONAL |
| ]] | | |
| [[ | | |

raFeatureCombinationParameters-rxx ::= SEQUENCE {

| raFeatureCombination-rxx FeatureCombinationIndication | | OPTIONAL, |
|---|---|---|
| startPreambleForThisPartition-rxx | INTEGER (1..64) | OPTIONAL, |
| numberOfPreamblesPerSSB-ForThisPartition-rxx INTEGER (1..64) | | OPTIONAL, |
| numberOfRA-PreamblesGroupA-rxx | INTEGER (1..64) | OPTIONAL, |
| Msg3Enabled-rxx | ENUMERATED {true} | OPTIONAL, |
| numberOfMsg3-Repetitions-rxx | ENUMERATED {n1, n2, n3, n4, n7, n8, n12, | |
| n16} OPTIONAL, | | |
| Nsagid-rxx | NSAG-ID-r17 | OPTIONAL, |

} //In another examples, the IEs listed within the group of
raFeatureCombinationParameters-rxx can independently included without grouping them into
raFeatureCombinationParameters-rxx.

| raLBTparameters-rxx ::= SEQUENCE { | | |
|---|---|---|
| lbt-FailureInstanceMaxCount-rxx | ENUMERATED {n4, n8, n16, n32, n64, | |
| n128} OPTIONAL, | | |
| lbt-FailureDetection Timer-rxx | ENUMERATED {ms10, ms20, ms40, ms80, ms160, | |
| ms320} OPTIONAL, | | |
| timeSincelbt-Failure-rxx | integer (0..320) | OPTIONAL, |
| numberOflbtFailureDetected | integer (0..xx) | OPTIONAL, |

}//In another example, the IEs listed within the group of
raFeatureCombinationParameters-rxx may be independently included without grouping them into

| raFeatureCombinationParameters-rxx. | | |
|---|---|---|
| raFailed ENUMERATED {true} | OPTIONAL, | |
| ]] | | |
| } | | |
| RA-InformationCommon-r16 ::= | SEQUENCE { | |
| absoluteFrequencyPointA-r16 | ARFCN-ValueNR, | |
| locationAndBandwidth-r16 | INTEGER (0..37949), | |
| subcarrierSpacing-r16 | SubcarrierSpacing, | |
| msg1-FrequencyStart-r16 | INTEGER (0..maxNrofPhysicalResourceBlocks-1) | |
| OPTIONAL, | | |
| msg1-FrequencyStartCFRA-r16 | INTEGER | |
| (0..maxNrofPhysicalResourceBlocks-1) | OPTIONAL, | |
| msg1-SubcarrierSpacing-r16 | SubcarrierSpacing | OPTIONAL, |
| msg1-SubcarrierSpacingCFRA-r16 | SubcarrierSpacing | OPTIONAL, |
| msg1-FDM-r16 | ENUMERATED {one, two, four, eight} | OPTIONAL, |
| msg1-FDMCFRA-r16 | ENUMERATED {one, two, four, eight} | |
| OPTIONAL, | | |
| perRAInfoList-r16 | PerRAInfoList-r16, | |
| ..., | | |
| [[ | | |
| perRAInfoList-v1660 PerRAInfoList-v1660 OPTIONAL | | |
| ]], | | |
| [[ | | |

msg1-SCS-From-prach-ConfigurationIndex-r16 ENUMERATED {kHz1dot25, kHz5,

```
spare2, spare1} OPTIONAL
    ]],
    [[
```

msg1-SCS-From-prach-ConfigurationIndexCFRA-r16 ENUMERATED {kHz1dot25,

| kHz5, spare2, spare1} OPTIONAL | | |
|---|---|---|
| ]], | | |
| [[ | | |
| msgA-RO-FrequencyStart-r17 | INTEGER | |
| (0..maxNrofPhysicalResourceBlocks-1) | OPTIONAL, | |
| msgA-RO-FrequencyStartCFRA-r17 | INTEGER | |
| (0..maxNrofPhysicalResourceBlocks-1) OPTIONAL, | | |
| msgA-SubcarrierSpacing-r17 | SubcarrierSpacing | OPTIONAL, |
| msgA-RO-FDM-r17 | ENUMERATED {one, two, four, eight} | |
| OPTIONAL, | | |
| msgA-RO-FDMCFRA-r17 | ENUMERATED {one, two, four, eight} | |
| OPTIONAL, | | |

msgA-SCS-From-prach-ConfigurationIndex-r17 ENUMERATED {kHz1dot25, kHz5,

spare2, spare1} OPTIONAL,

msgA-TransMax-r17 ENUMERATED {n1, n2, n4, n6, n8, n10, n20, n50, n100, n200}

| OPTIONAL, | | |
|---|---|---|
| msgA-MCS-r17 | INTEGER (0..15) | OPTIONAL, |
| nrofPRBs-PerMsgA-PO-r17 | INTEGER (1..32) | OPTIONAL, |
| msgA-PUSCH-TimeDomainAllocation-r17 | INTEGER (1..maxNrofUL-Allocations) | |
| OPTIONAL, | | |
| frequencyStartMsgA-PUSCH-r17 | INTEGER | |
| (0..maxNrofPhysicalResourcesBlocks-1) | OPTIONAL, | |
| nrofMsgA-PO-FDM-r17 | ENUMERATED {one, two, four, eight} | |
| OPTIONAL, | | |
| dlPathlossRSRP-r17 RSRP-Range OPTIONAL, | | |
| intendedSIBs-r17 | SEQUENCE (SIZE (1..maxSIB)) OF SIB-Type-r17 | |
| OPTIONAL, | | |
| ssbsForSI-Acquisition-r17 | SEQUENCE (SIZE (1..maxNrofSSBs-r16)) OF SSB- | |
| Index OPTIONAL, | | |
| msgA-PUSCH-PayloadSize-r17 | BIT STRING (SIZE (5)) | OPTIONAL, |
| onDemandSISuccess-r17 | ENUMERATED {true} | OPTIONAL |
| ]] | | |
| } | | |

```
  PerRAInfoList-r17 ::= SEQUENCE (SIZE (1..200)) OF PerRAInfo-r16
  PerRAInfoList-v1660 ::= SEQUENCE (SIZE (1..200)) OF PerRACSI-RSInfo-v1660
```

| PerRAInfo-r16 ::= | CHOICE { | |
|---|---|---|
| perRassBInfoList-r16 | PerRASSBInfo-r16 | |
| perRACSI-RSInfoList-r16 | PerRACSI-RSInfo-r16 | |
| } | | |
| PerRASSBInfo-r16 ::= | SEQUENCE { | |
| ssb-Index-r16 | SSB-Index, | |
| numberOfPreamblesSentOnSSB-r16 | INTEGER (1..200), | |
| perRAAttemptInfoList-r16 | PerRAAtemptInfoList-r16, | |
| numberOfLBTFailureReceivedOnSSB-rxx | INTEGER (1..N) | OPTIONAL, |
| lbt-FailureIndicationRecievedSSB-rxx | ENUMERATED {true} | OPTIONAL, |
| } | | |
| PerRACSI-RSInfo-r16 ::= | SEQUENCE { | |
| csi-RS-Index-r16 | CSI-RS-Index, | |
| numberOfPreamblesSentOnCSI-RS-r16 | INTEGER (1..200), | |
| numberOfLBTFailureReceivedOnCSI-RS-rxx | INTEGER (1..n) | OPTIONAL, |
| lbt-FailureIndicationReceivedCSI-RS-rxx | ENUMERATED {true} | OPTIONAL, |
| } | | |
| PerRACSI-RSInfo-v1660 ::= | SEQUENCE { | |
| csi-RS-Index-v1660 | INTEGER (1..96) OPTIONAL | |
| } | | |
| PerRAAttempInfoList-r16 ::= | SEQUENCE (SIZE (1..200)) OF PerRAAtemptInfo-r16 | |
| PerRAAttemptInfo-r16 ::= | SEQUENCE { | |
| contention Detected-r16 | BOOLEAN | OPTIONAL, |
| dIRSRPAboveThreshold-r16 | BOOLEAN | OPTIONAL, |
| ..., | | |
| [[ | | |
| fallbackToFourStepRA-r17 | ENUMERATED {true} | OPTIONAL |
| ]] | | |
| [[ | | |
| backoffIndexRecieved-rxx | ENUMERATED {true} | OPTIONAL, |
| ]] | | |
| } | | |
| [Some IEs are ommitted] | | |

-- TAG-UEINFORMATIONRESPONSE-STOP

-- ASN1STOP

RA-InformationCommon field descriptions

raFeatureCombination-rxx
indicate the types of Feature Combination associated to this RA procedure. For
example, msg3-Repetitions means Msg3 repetition (or coverage enhancement),
smallData means small data transmission, redCap means RedCap, nsag indicates NW
slicing.
Msg3Enabled
Indicates whether Msg3 repetition is enabled or not for this RA procedure.
numberOfMsg3-Repetitions
Indicates the number of repetitions for PUSCH transmission scheduled by RAR UL grant
and DCI format 0_0 with CRC scrambled by TC-RNTI used in this RA procedure. This
field is optionally present when Msg3 repetition is configured and used.
Nsagid
indicate slice group identity the RA procedure is initiated on
timeSincelbt-Failure
indicate the running time of lbt-FailureDetectionTimer until completion of this RA
procedure.
numberOflbtFailureDetected
Indicates the number of LBT failure detection detected in this RA procedure.
raFailed
Indicate whether the RA procedure fails or not. Presence of this field indicates the RA
procedure fails otherwise it is not included, which means RA is successful.

RA-Report field descriptions

numberOfLBTFailureReceivedOnSSB-rxx
Indicates the number of LBT failure detection received in this SSB.
lbt-FailureIndicationRecievedSSB
Indicates whether LBT failure detection is received in this SSB. or not. Presence of this
field indicates LBT failure detection is received at least once in this SSB otherwise it is
absent, which implies no LBT failure indication is received.
numberOfLBTFailureReceivedOnCSI-RS
Indicates the number of LBT failure detection received in this CSI-RS.
lbt-FailureIndicationRecievedCSI-RS
Indicates whether LBT failure detection is received in this CSI-RS or not. Presence of
this field indicates LBT failure detection is received at least once in this CSI-RS otherwise
it is absent, which implies no LBT failure indication is received.
backoffIndexRecieved
indicates whether backoff indication is received for this RA attempt or not. Presence of
this field indicates backoff indication is received for this attempt otherwise it is absent,
which implies no backoff indication is received.

FIG. 6 relates to a schematic diagram of a wireless terminal 60 according to an embodiment of the present disclosure. The wireless terminal 60 may be a user equipment (UE), a mobile phone, a laptop, a tablet computer, an electronic book or a portable computer system and is not limited herein. The wireless terminal 60 may include a processor 600 such as a microprocessor or Application Specific Integrated Circuit (ASIC), a storage unit 610 and a communication unit 620. The storage unit 610 may be any data storage device that stores a program code 612, which is accessed and executed by the processor 600. Embodiments of the storage unit 610 include but are not limited to a subscriber identity module (SIM), read-only memory (ROM), flash memory, random-access memory (RAM), hard-disk, and optical data storage device. The communication unit 620 may a transceiver and is used to transmit and receive signals (e.g., messages or packets) according to processing results of the processor 600. In an embodiment, the communication unit 620 transmits and receives the signals via at least one antenna 622 shown in FIG. 6.

In an embodiment, the storage unit 610 and the program code 612 may be omitted and the processor 600 may include a storage unit with stored program code.

The processor 600 may implement any one of the steps in exemplified embodiments on the wireless terminal 60, e.g., by executing the program code 612.

The communication unit 620 may be a transceiver. The communication unit 620 may as an alternative or in addition be combining a transmitting unit and a receiving unit configured to transmit and to receive, respectively, signals to and from a wireless network node (e.g., a base station).

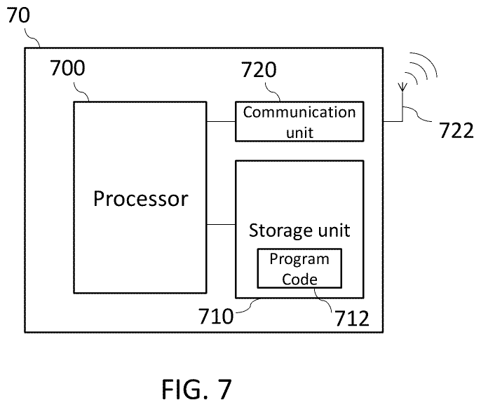

FIG. 7 relates to a schematic diagram of a wireless network node 70 according to an embodiment of the present disclosure. The wireless network node 70 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 70 may comprise (perform) at least one network function such as an access and mobility management function (AMF), a session management function (SMF), a user place function (UPF), a policy control function (PCF), an application function (AF), etc. The wireless network node 70 may include a processor 700 such as a microprocessor or ASIC, a storage unit 710 and a communication unit 720. The storage unit 710 may be any data storage device that stores a program code 712, which is accessed and executed by the processor 700. Examples of the storage unit 710 include but are not limited to a SIM, ROM, flash memory, RAM, hard-disk, and optical data storage device. The communication unit 720 may be a transceiver and is used to transmit and receive signals (e.g., messages or packets) according to processing results of the processor 700. In an example, the communication unit 720 transmits and receives the signals via at least one antenna 722 shown in FIG. 7.

In an embodiment, the storage unit 710 and the program code 712 may be omitted. The processor 700 may include a storage unit with stored program code.

The processor 700 may implement any steps described in exemplified embodiments on the wireless network node 70, e.g., via executing the program code 712.

The communication unit 720 may be a transceiver. The communication unit 720 may as an alternative or in addition be combining a transmitting unit and a receiving unit configured to transmit and to receive, respectively, signals to and from a wireless terminal (e.g., a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

I/We claim:

1. A wireless communication method for use in a wireless terminal, the method comprising:
reporting, to a wireless network node, random access, RA, information of at least one RA procedure,
wherein the RA information comprises information associated with utilizing RA channel, RACH, resources associated with one or more features that are applicable for the RA procedure.

2. The wireless communication method of claim 1, wherein the RA information of each RA procedure comprises at least one of:
a feature type, indicating one or more features of a Feature Combination associated with the RA procedure,
a first preamble associated with the Feature Combination associated with the RA procedure,
a number of consecutive preambles associated with the Feature Combination per Synchronization Signal/Physical broadcast channel block, SSB,
a number of consecutive preambles per SSB which are associated with a preamble group for the Feature Combination,
feature priorities, indicating priorities for the one or more features of the Feature Combination,
an indication on whether a message 3, Msg3, repetition is enabled per RA procedure, per beam or per RA attempt,
a number of Msg3 repetitions per RA attempt or per beam,
a modulation and coding scheme for the Msg3 repetition,
a number of repetitions for a physical uplink shared channel transmission scheduled by an RA radio network temporary identifier uplink grant and downlink control information format 0_0,
network slice related information associated with the RA procedure,
at least one network slice group identity associated with the RA procedure,
at least one backoff value associated with the RA procedure,
at least one scaling factor associated with the at least one backoff value,
an indication on whether backoff index is received for the RA procedure,
at least one power ramping step used in the RA procedure,
at least one purpose associated with the at least one power ramping step,
an access identity associated with the RA procedure, or
an indication on whether the RA procedure is successful or not.

3. The wireless communication method of claim 2, wherein the one or more features of the Feature Combination associated with the RA procedure comprises at least one of:
a reduced capability,
a Msg3 repetition,
a small data transmission, or
a network slicing.

4. The wireless communication method of claim 2,
wherein the first preamble associated with the Feature Combination associated with the RA procedure is indicated by an integer with a value range from 1 to 64.

5. The wireless communication method of claim 2, wherein the number of consecutive preambles associated with the Feature Combination per SSB is indicated by an integer with a value range from 1 to 64.

6. The wireless communication method of claim 2, wherein the number of consecutive preambles per SSB which are associated with the preamble group for the Feature Combination is indicated by an integer with a value range from 1 to 64.

7. The wireless communication method of claim 1, wherein the RA information comprises information associated with the RA procedure in a shared spectrum.

8. The wireless communication method of claim 1, wherein the RA information comprises at least one of:
a configuration for detecting consistent uplink listen-before-talk, LBT, failures in a shared spectrum channel access,
an indication of the RA procedure being initiated for LBT failure recovery,
an indication of whether a LBT failure indication is received per RA attempt in the shared spectrum,
a number of LBT failure indication received per beam or per consecutive attempt within one beam in the RA procedure or per RA procedure in the shared spectrum,
an indication on whether the RA procedure in the shared spectrum is successful,
an indication on whether a LBT recovery is successful,
a number of transmission opportunities configured per bandwidth part for each RA procedure in an unlicensed spectrum,
a running time of a timer associated with a LBT failure detection,
a number of detected LBT failures per bandwidth part or per cell, or
an indication of whether consistent LBT is detected in a bandwidth part;
wherein the configuration for detecting the consistent uplink LBT failures in the shared spectrum channel access comprises at least one of:
a length of a timer for the consistent uplink LBT failure detection, or
a maximum number of LBT failure indications received from a physical layer before triggering an uplink LBT failure recovery.

9. The wireless communication method of claim 1, further comprising:
receiving, from the wireless network node, an RA configuration determined based on the RA information.

10. The wireless communication method of claim 1, further comprising:
receiving, from the wireless network node, a request for a capability indication; and
transmitting, to the wireless network node, the capability indication associated with reporting the RA information relevant to RA procedure utilizing RA resources associated with a Feature Combination of the RA procedure.

11. A wireless communication method for use in a wireless network node, the method comprising:
receiving, from a wireless terminal, random access, RA, information of at least one RA procedure, and
determining a RA configuration associated with the RA procedure of the wireless terminal; and wherein the RA information comprises information associated with utilizing RA channel, RACH, resources associated with one or more features that are applicable for the RA procedure.

12. The wireless communication method of claim 11, wherein the RA information of each RA procedure comprises at least one of:
a feature type, indicating one or more features of a Feature Combination associated with the RA procedure,
a first preamble associated with the Feature Combination associated with the RA procedure,
a number of consecutive preambles associated with the Feature Combination per Synchronization Signal/Physical broadcast channel block, SSB,
a number of consecutive preambles per SSB which are associated with a preamble group for the Feature Combination,
feature priorities, indicating priorities for the one or more features of the Feature Combination,
an indication on whether a message 3, Msg3, repetition is enabled per RA procedure, per beam or per RA attempt,
a number of Msg3 repetitions per RA attempt or per beam,
a modulation and coding scheme for the Msg3 repetition,
a number of repetitions for a physical uplink shared channel transmission scheduled by an RA radio network temporary identifier uplink grant and downlink control information format 0_0,
network slice related information associated with the RA procedure,
at least one network slice group identity associated with the RA procedure,
at least one backoff value associated with the RA procedure,
at least one scaling factor associated with the at least one backoff value,
an indication on whether backoff index is received for the RA procedure,
at least one power ramping step used in the RA procedure,
at least one purpose associated with the at least one power ramping step,
an access identity associated with the RA procedure, or
an indication on whether the RA procedure is successful or not.

13. The wireless communication method of claim 12, wherein the one or more features of the Feature Combination associated with the RA procedure comprises at least one of:
a reduced capability,
a Msg3 repetition,
a small data transmission, or
a network slicing.

14. The wireless communication method of claim 12,
wherein the first preamble associated with the Feature Combination associated with the RA procedure is indicated by an integer with a value range from 1 to 64.

15. The wireless communication method of claim 12, wherein the number of consecutive preambles associated with the Feature Combination per SSB is indicated by an integer with a value range from 1 to 64; and
wherein the number of consecutive preambles per SSB which are associated with the preamble group for the Feature Combination is indicated by an integer with a value range from 1 to 64.

16. The wireless communication method of claim 12, wherein each network slice group identity is indicated by a bitstring.

17. The wireless communication method of claim 12, wherein the at least one backoff value is indicated by at least one backoff index, and
wherein each ramping step used in the RA procedure is indicated as a value in a value set.

18. The wireless communication method of claim 11, wherein the RA information comprises at least one of:
a configuration for detecting consistent uplink listen-before-talk, LBT, failures in a shared spectrum channel access,
an indication of the RA procedure being initiated for LBT failure recovery,
an indication of whether a LBT failure indication is received per RA attempt in the shared spectrum,
a number of LBT failure indication received per beam or per consecutive attempt within one beam in the RA procedure or per RA procedure in the shared spectrum,
an indication on whether the RA procedure in the shared spectrum is successful,
an indication on whether a LBT recovery is successful,
a number of transmission opportunities configured per bandwidth part for each RA procedure in an unlicensed spectrum,
a running time of a timer associated with a LBT failure detection,
a number of detected LBT failures per bandwidth part or per cell, or
an indication of whether consistent LBT is detected in a bandwidth part.

19. The wireless communication method of claim 11, further comprising:
receiving, from the wireless terminal, a capability indication associated with reporting the RA information relevant to RA procedure utilizing RA resources associated with a Feature Combination of the RA procedure; and
transmitting, to the wireless terminal, a request for the capability indication.

20. An apparatus, comprising:
a communication unit and at least one processor;
wherein the communication unit is configured to report, to a wireless network node, random access, RA, information of at least one RA procedure; and
wherein the RA information comprises information associated with utilizing RA channel, RACH, resources associated with one or more features that are applicable for the RA procedure.
